(19) United States
(12) Patent Application Publication
(10) Pub. No.: US 2006/0282886 A1
(43) Pub. Date: Dec. 14, 2006

(54) Service oriented security device management network

(75) Inventor: Mark Gaug, Vestal, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation

(21) Appl. No.: 11/449,657

(22) Filed: Jun. 9, 2006

Related U.S. Application Data
(60) Provisional application No. 60/688,725, filed on Jun. 9, 2005.
(60) Provisional application No. 60/688,724, filed on Jun. 9, 2005.

(51) Int. Cl. H04L 9/32

(52) U.S. Cl. 726/5

(57) ABSTRACT

A service oriented security device management system is disclosed. The management system may include a control center coupled to a network, a service oriented security device network interface coupled to a network and a security device interface module coupled to a security device. The control center may include a business logic rules module configured to determine a need to provide or consume a service and a service oriented architecture messaging module configured to send a message requesting a service and to send a message responding to a request for service. The security device interface module may include a service oriented architecture communications module configured to communicate with the service oriented architecture messaging module of the at least one control center via the network and a business rules engine coupled to the service oriented architecture communications module. The security device interface module may include a functional software module coupled to the business rules engine and a translator software module coupled to the business rules engine.

The present application claims priority under 35 U.S.C. § 119(e) to U.S. Provisional Application No. 60/688,725, entitled “Centralized Security Equipment Management Utilizing a Service Oriented Architecture (SOA)”, filed Jun. 9, 2005, and U.S. Provisional Application No. 60/688,724, entitled “Information Routing In A Distributed Environment”, filed Jun. 9, 2005 both of which are incorporated herein by reference in their entirety.

An embodiment of the disclosed invention relates generally to a computerized network of devices, and, more particularly, to a service oriented security device management network.

Airports, and other facilities where security devices may be desired, may employ different types of security devices or equipment in an attempt to detect potential threats to security. It may be desirable to connect the security devices (or machines) into a network for centralized communication, control, and/or management. Conventional methods of connecting the security devices in a centrally managed network may be difficult, expensive, and/or time consuming due to the potentially different makes and models of the machines. Upgrading the software in a conventional centralized management system may be difficult, expensive, or time consuming. Also, the security devices may be located within a single facility or distributed across a geographical area presenting additional problems for a central communications and control facility using conventional techniques.

Security devices, such as, for example, airport screening equipment (threat image projection x-ray machines, explosive trace detectors, explosive detection systems, walk through metal detectors, and the like) may often be stand alone machines. This equipment may have network connections, but may not be managed from a central location. There may be a desire to centrally control these devices, for example through the Security Technology Integrated Program (STIP).

An exemplary embodiment of this invention relates to a service oriented architecture approach to providing a centralized management network for security devices, for example, in terminal/airport/regional and/or national/international centralized control and data management center(s). A Service Oriented Architecture (SOA) embodiment in accordance with the present disclosure may allow the entire management task to be broken down into objects that are individually network addressable. A business rules engine using scripting may then invoke the objects and tie them together in a coherent application based on one or more business rules, as described in greater detail below. A network of security devices may be managed using services provided by the objects via the business rules engine and associated scripting.

An exemplary SOA embodiment of the present invention may also allow additional functionality to be added with a change of script and additional software objects. This approach may reduce or eliminate a need for a recompile/re-release cycle of an entire application to add additional functionality. It may also allow software updates to be developed and supplied from multiple sources.

In another example, an aspect of the present disclosure is directed to reducing a need for a control and management system to have knowledge of communications requirements specific to a particular make and model of threat scanning machines, for example, through a service oriented architecture (SOA) system. The SOA control and management system may be loosely coupled to the individual scanning devices though SOA interface coupled to each device under control of the control and management system.

### BRIEF DESCRIPTION

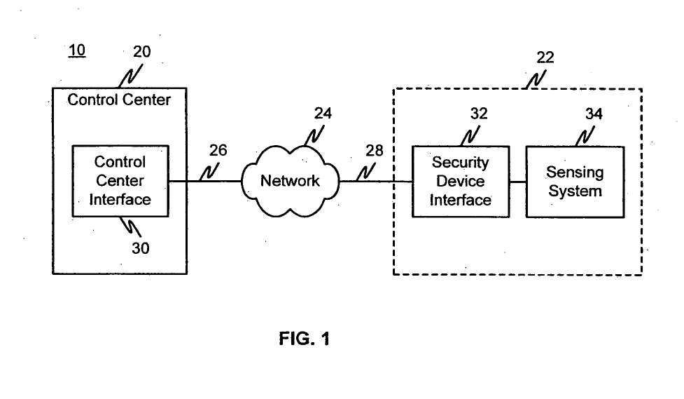

FIG. 1 provides a block diagram representation of an exemplary disclosed security device network;

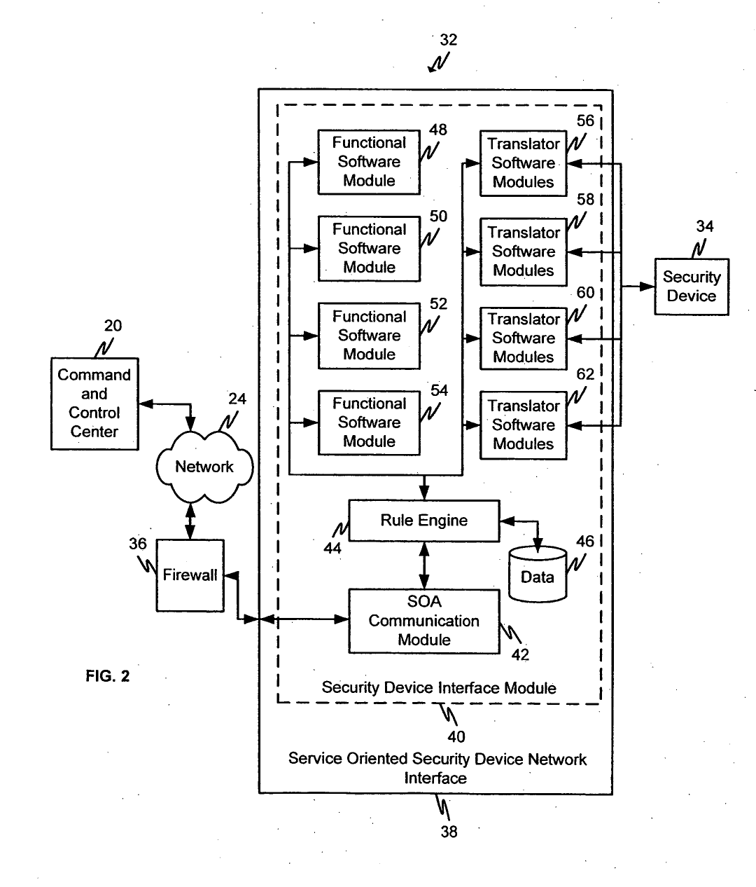

FIG. 2 provides a block diagram representation of an exemplary disclosed interface for a security device;

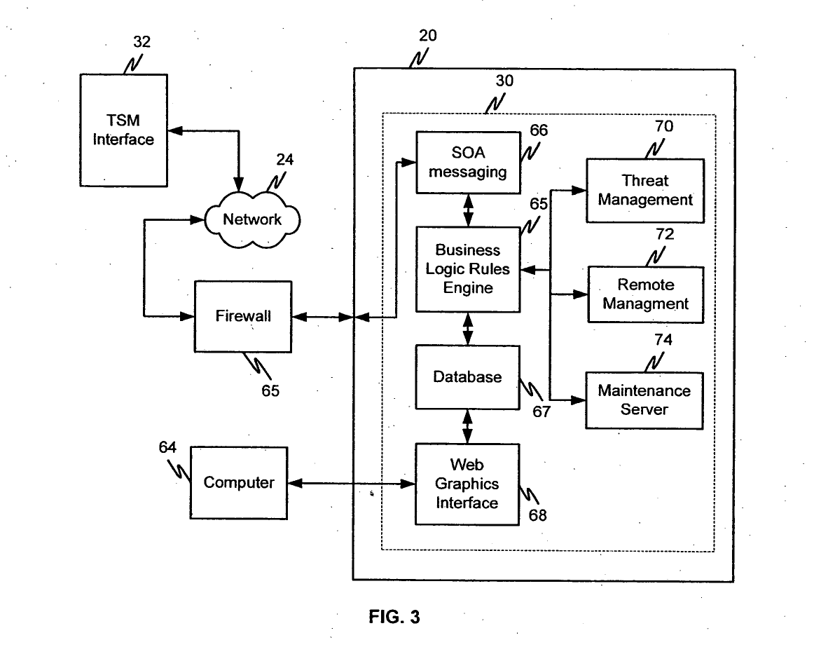

FIG. 3 provides a block diagram representation of an exemplary disclosed interface for a control center;

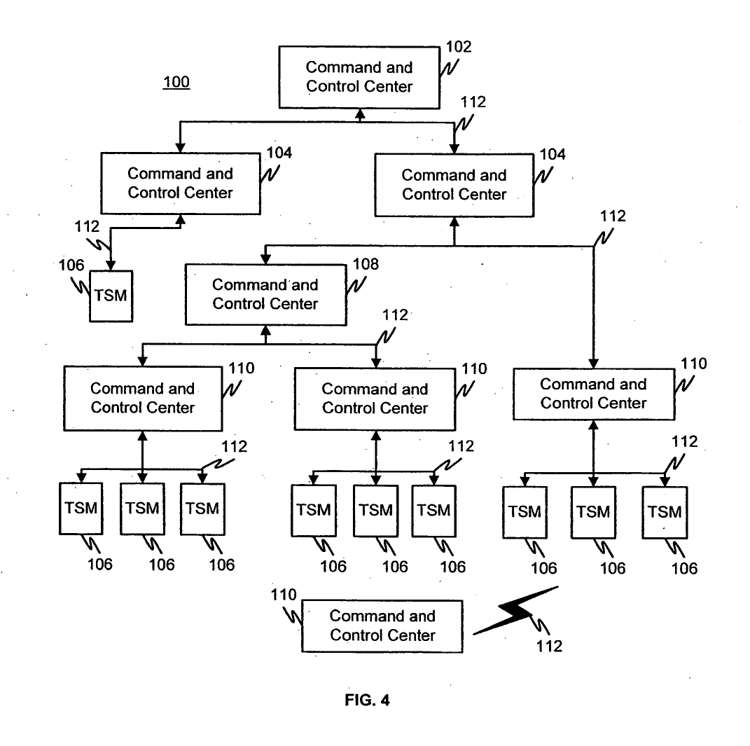

FIG. 4 provides a block diagram representation of an exemplary hierarchical arrangement of control centers and security devices;

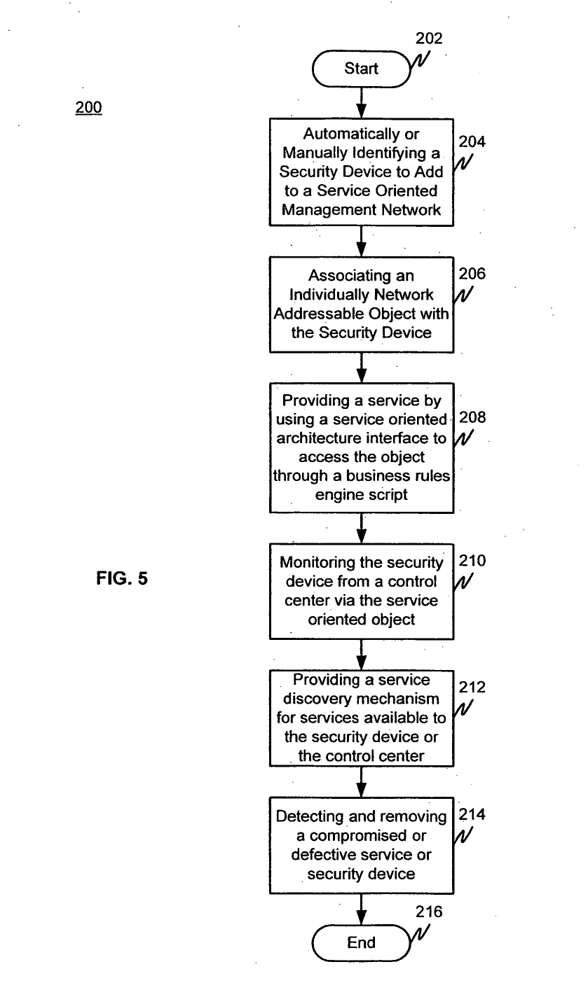

FIG. 5 provides a flowchart representing an exemplary disclosed method for managing a network of security devices; and

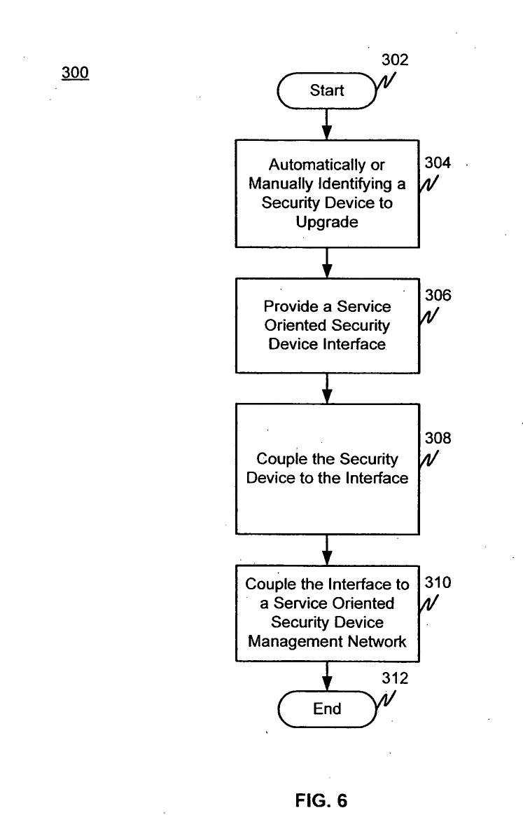

FIG. 6 provides a flowchart representing an exemplary disclosed method for upgrading a security device.

### DETAILED DESCRIPTION

FIG. 1 provides a block diagram representation of an exemplary disclosed security device management network 10 using a service oriented architecture. The security device management network 10 may include a control center 20 and a security device 22 communicating with each other across a network 24. The control center 20 may be linked to the network 24 via link 26. The security device 22 may be linked to the network 24 via link 28. The control center 20 may include a control center interface 30. The security device 22 may include a security device interface 32 and a sensing system 34.

Although one control center 20 and one security device 22 are shown in FIG. 1 for illustration purposes, it should be appreciated that the disclosed service oriented management network, and associated interfaces and methods, may be applicable to more than one control center 20 and more than one security device 22. The links 26 and 28 may each be a wired link, a wireless link, or a combination of the above. The network 26 may be a public network (e.g. the internet), a private network, an internal network, an external network, and/or a combination of the above.

The security device 22 may include threat scanning equipment, surveillance equipment, perimeter or area intrusion detection equipment, and/or the like. Threat scanning equipment (or security devices) may include x-rays, metal detectors, chemical sensors, imaging devices, shipping container inspection devices, and/or the like. Threat scanning equipment may include electrical, mechanical, chemical, nuclear, and/or biological sensors in order to attempt to detect potential security threats. The terms “threat scanning machine” and “security device” as used in this disclosure are intended to be interchangeable and may include one or more of the various devices listed above.

In operation, the control center 20 may use a service oriented architecture (SOA) management network system to control, manage, and/or communicate with the security device 22. An SOA system may include a collection of services that may communicate with each other. The communication may involve simple data passing or it may involve two or more services coordinating an activity. Services may be connected to each other. An SOA may provide loose coupling among interacting software agents. A service may be a logical unit of work done by a service provider to achieve a desired end result for a service consumer. Both the service provider and the service consumer may be roles played by software agents on behalf of their owners (or controlling applications or scripts). For example, in a security device update service, a control center may be a provider of updated security device software and the security device may be a consumer requesting updated software if available. It should be appreciated that the control center 20 and security device 22 may each be a service provider and/or service consumer.

An SOA system may be different from an object oriented programming architecture, which may encourage binding data and related processing together. An SOA may achieve loose coupling among interacting software agents by employing two architectural constraints: a small set of simple, generic, and/or ubiquitous interfaces and descriptive messages constrained by an extensible schema delivered through the interfaces. The small set of simple and ubiquitous interfaces may be available to a portion or all of the participating software agents. Generic semantics may be encoded at the interfaces. The interfaces may be universally available for all providers and consumers. The descriptive massages may contain little or no prescribed system behavior. A schema may limit the vocabulary and/or structure of messages. An extensible schema may allow new versions of services to be introduced without causing existing services to become inoperable. In other words, existing service interfaces may be left intact while new interfaces are added (i.e. the schema may be extended), thus allowing the existing service to still function along with a new service. It should be appreciated that while goals of an SOA may differ from an object oriented architecture, object oriented programming and/or languages may be used to implement a portion of the SOA systems and methods of the present invention.

Interfacing may be of significant importance in the disclosed SOA security device management network. For example, if the interfaces between a control center 20 and a security device 22 do not work, then the control and communication system may not work. Interfacing may also be expensive and error-prone for distributed applications. An interface may need to prescribe system behavior, which may be very difficult to implement correctly across different platforms and languages. Remote interfaces may often be the slowest part of a typical distributed application. For these reasons, among others, the SOA systems and methods of the present disclosure may be implemented using a few generic interfaces that may be reused, instead of building new interfaces for each application. Because only a few generic interfaces may be available, application-specific semantics may be expressed within messages. Any kind of message may be sent over the interfaces, but rules may need to be followed in order for the architecture to be a service oriented architecture.

The messages sent and received by the disclosed SOA security device management network may be descriptive, rather than instructive, because the service provider may be responsible for solving the problem. In other words, a service provider may be better positioned to determine how to perform a service, while a service consumer may be in a better position to determine what services are needed or desired.

Service providers in the disclosed system may be unable to process a request if a message containing the request is not composed in a format, structure, and/or vocabulary that may be processed by both the service provider and a service consumer (or requester). Limiting the vocabulary and structure of messages may result in an efficient communication. Further, the more restricted a message may be, the easier it may be to process the message. Although it should be appreciated that message restriction may come at the expense of reduced extensibility.

Extensibility may be a preferred aspect of communications between service providers and services consumers in the disclosed security device management network. For example, software and/or hardware changes may demand corresponding changes in the software system, service consumers, providers, and the messages they exchange. If messages were not extensible, consumers and providers may be locked into one particular version of a service. Extensibility may provide for a cost effective method of updating service messages to reflect changes in a system or in a component of the system.

A service discovery mechanism that enables a consumer to discover a service provider under the context of a service sought by the consumer may be a desirable aspect of the disclosed SOA security device management network. The service discovery mechanism may be flexible, and may include a centralized registry.

The disclosed SOA systems and methods may be subject to additional constraints that may be applied in order to improve scalability, performance, and/or reliability. The additional restraints may include stateless service, stateful service, and idempotent request. In a stateful service SOA system, each message that a consumer sends to a provider may contain all necessary information for the provider to process it. This constraint may provide a service provider with greater scalability because the provider does not have to store state information between requests.

Stateful service may be useful in a number of situations, such as, for example, establishing a session between a consumer and a provider. A session may typically be established for efficiency reasons. For example, sending a security certificate with each request may present a serious burden for both consumer and provider. It may be less burdensome to replace the security certificate with a token shared just between the consumer and provider. Stateful services may require both the consumer and the provider to share the same consumer-specific context, which is either included in or referenced by messages exchanged between the provider and the consumer. A potential drawback of the stateful service constraint may be that it may reduce the overall scalability of the service provider because it may need to remember the shared context for each consumer. It may also increase the coupling between a service provider and a consumer and makes switching service providers more difficult.

In an exemplary disclosed idempotent request restrained system, duplicate requests received by a software agent have the same effects as a unique request. An idempotent request embodiment may allow providers and consumers to improve the overall service reliability by simply repeating the request if faults are encountered.

The disclosed SOA security device management network may include interfaces based on standard Internet protocols such as, for example, hypertext transfer protocol (HTTP), file transfer protocol (FTP), simple mail transfer protocol (SMTP), and/or other current or later developed protocols. Also, the messages may be in extensible markup language (XML), or other current or later developed languages. For some messages, XML (or another such language) may not be appropriate, such as, for example, binary data attachments.

The disclosed SOA security device management network may be implemented using standard techniques, such as, for example, one of the styles currently in use for Internet web services: simple object access protocol (SOAP) web services and representational state transfer (REST) web services. SOAP may serve to form a foundation layer of a web services stack, providing a basic messaging framework that more abstract layers can build on. In an SOAP embodiment of the disclosed security device management network, messages may be carried by SOAP and a description of the service may be in web services description language (WSDL). WSDL is an XML format for describing network services as a set of endpoints operating on messages containing either document-oriented or procedure-oriented information. SOAP messages may be exchanged over a variety of underlying protocols. SOAP may provide rich message exchange patterns ranging from traditional request-and-response to broadcasting and sophisticated message correlations.

In a REST embodiment of the disclosed security device management network, the SOA may be based on the concept of a “resource”. A resource may be anything that has a uniform resource identifier (URI). A resource may include zero or more representations. A REST web service may include interfaces limited to HTTP and messages in XML, and may provide encoding of simple messages with URL encoding.

The SOA components of the interface described above in relation to the control center 20 and the security device 22 may be constructed as a component of a new device or may be configured to be an upgrade to an existing control center or security device. An exemplary method of upgrading a security device is described below in relation to FIG. 6.

FIG. 2 provides a block diagram representation of an exemplary disclosed security device interface. In particular, the security device 22 may be coupled to the network 24 through a firewall 36. The security device interface 32 may include a service oriented security device network interface 38 and a security device interface module 40. The security device interface module 40 may include an SOA communication module 42, a business rule engine module 44, a database 46, one or more functional software modules (48-54), and one or more translator software modules (56-62). Although labeled as functional software modules and translator software modules for illustration purposes, it should be appreciated that any modules in the security device interface may be implemented in software, hardware, or a combination of the above.

In FIG. 2, two types of interface modules are shown: translator software modules (56-62) and functional software modules (48-54). The translator software modules (56-62) and functional software modules (48-54) may each include individually network addressable objects. The translator software modules (56-62) may translate data received from a control center format to a format suitable for use within the security device or the security device interface. For example, the translator software modules (56-62) may include interfaces for scanning machine specific messages and data buses; scanning machine (or associate) databases; scanning machine file system, system registries, event logs, XML data sources, system resource usage and allocations, and/or system authentication data stores; and/or the like.

The functional software modules (48-54), may be configured to perform or provide a security device service, such as, for example, capturing, transmitting, commanding, or otherwise communicating to the security device (through an interface module) in relation to a task or a group of tasks. Examples of functional modules include modules configured to provide functions including property management; hardware inventory; software inventory; software distribution; configuration management; remote hardware/network/software diagnostics; alarm, error, and warning event status notification, and escalation; data archiving, backup, purging and management; remote access to security device and command center assets; user and system authentication and authentication setup; auditing of some or all actions taken; auditing of some or all messages received; routing of command signals; remote configuration of individual security devices; threat image insertion management; scoring the accuracy of security device screeners; staged storage of images and data; interpreting and reporting security device performance data; remote viewing of images acquired by a security device; searching, displaying, and managing threat data over a distributed network; update of security device threat libraries; screener performance measurement and efficiency reporting; escalation and management of detected threats, and alarms; screener/supervisor communication; linking of passenger identification between remote databases; linking other security device scans of a specific article; scheduling update or software/download of files; remote control of screener/user functions; command and control of security device; gathering of computer/system/user diagnostic data; remote training of users; storing and queuing of information; configuration of the security device; report generation; remote desktop sharing; reporting security device utilization; reporting security device performance; communication of data, image, training, configuration, audit, database, and/or registry data to a central command center for centralized management, archiving, or temporary storage; capturing and reporting of security device operator keystroke information; remote restart monitoring; screener user tracking and time keeping; traveler identification information gathering, comparison to existing databases, and correlating to baggage; security encryption of data stream; and/or the like. It should be appreciated that the functional modules may perform a portion or all of a service or task, and that functional modules (48-54) performing a portion of a task may be accessed in a sequence determined, for example, by a script in the business rule engine 44 in order to provide a complete service. It should also be appreciated that the number of functional modules and translator modules shown in FIG. 2 is for illustration purposes and more or less functional modules and/or translator modules may be used depending upon a contemplated use of the disclosed invention.

The service oriented security device network interface module 38 may allow a common piece of software to control system access, security, and message routing. New functionality may be added with relative ease to the interface through plug-in modules and may be rapidly configured with changes to a script in the business rules engine to include new security devices, changes in monitoring requirements, or the like. These changes can be accomplished without a software release to the underlying software. In addition, an XML web services embodiment of the management network may provide messaging that may readily pass through firewalls. Each security device interface module 40 may provide for local storage of threat, training, maintenance, system management, configuration, image libraries, audit files, and/or the like.

As used herein, the phrase. “business rules” refers to rules or rulesets that may describe the operations, definitions and/or constraints that may apply to an organization in achieving its goals. Although the term “business rule” may be used throughout this description in order to aid understanding of those persons of ordinary skill in the art, it should be appreciated that the business rules may pertain to organizations other than businesses. For example, a business rule in the threat scanning machine context may state that a software update must be performed according to a certain schedule. These business rules may be used to help an organization achieve goals, communicate among organization members, communicate between the organization and interested third parties, demonstrate fulfillment of legal obligations, operate more efficiently, automate operations, perform analysis on current practices, and/or the like.

A business rules engine, (or business logic rules module or rule engine), may be a software system or module that provides rule management functions. The rule engine module may, among other functions, help to register, classify and manage rules; verify consistency of rules; infer some rules based on other rules; and relate some of these rules to other services or processes that may be affected or need to enforce one or more of the rules. Rules may also be used to detect situations automatically. For example, a threat scanning rule may be, for example, “notify a supervisor when the same passenger bag has activated an alarm at two different threat scanning machines in the same day.”

In an embodiment of the disclosed network management system, the business rules may change more frequently than the rest of the application code. The business rules engine (rule engine or inference engine) may be a pluggable software component that separates the business rules from the application code. This implementation may allow users of the system to modify the rules frequently while minimizing a need for intervention by technician skilled in software programming, and, hence, may allow the applications to be more adaptable with the dynamic rules. Data may typically be dynamic and may be operated upon by the logic and rules to obtain a desired result. The present invention provides for the dynamic rules in addition to processing dynamic data.

The rules may be production/inference rules or reaction rules. Production/inference rules may be used to answer questions and/or infer answers. For example, such a rule could answer the question: “should a particular passenger be allowed to board an aircraft?” The reactive rules may be used to detect and react to patterns of events occurring. For example, a reactive rule engine could be used to alert a supervisor when a certain pattern of threat alarms occurs among various threat scanning machines. A rule engine processing a production rule may answer questions when a user or application submits the question. A rule engine processing a reactive rule may react automatically, for example, when a certain rule is violated the service may sound an alarm.

FIG. 3 provides a block diagram representation of an exemplary disclosed control center interface 30. In particular, a computer 64 may be coupled to the control center 20, which may be coupled to the network 24 via a firewall 65. The control center interface 30 may include a business logic rules module 65, an SOA messaging module 66, a database 67, a web graphics module 68, a threat management module 70, a remote management module 72, and a maintenance server module 74.

A geographic location of a control center (or command center) may not be important as long as there is an internet connection to the network, because the service oriented management network may pass messages from one or more control centers to individual security device interfaces as shown in FIG. 4. The management network may allow the system to be dynamically configurable to respond to changes in demand for processing or changes in capacity. For example, if one control center is not able to meet the processing demands, or should encounter a failure, another control center can be dynamically configured to perform any overflow processing from the overloaded or failed control center.

Messages to and from the security device and control center may include composed of XML and/or include Simple Object Access Protocol (SOAP) format messages, which (before encryption) may be human readable and self-descriptive, providing messages that are easy to troubleshoot. Message translation problems between different operating systems and memory storage formats may be reduced or eliminated. XML tags and available Document Object Model (DOM) processing algorithms may allow for filtering and aggregation of message data.

The disclosed SOA management network may include XML web services to communicate to and from airport equipment, or other secure facility equipment. The XML web service messages may include hypertext transfer protocol (HTTP) (although other transport methods, such as E-Mail, HTTPS, or the like may also be used) to communicate. The web service protocol may be routed through firewalls, allowing encrypted information to be routed to/from any site having network access, such as, for example, internet access. The disclosed management system may provide near-real-time, two-way communications between security devices and control centers through polling and/or asynchronous communication.

An exemplary service oriented management network may include commercial off the shelf (COTS) business rules engines to implement the basic message routing, tracking, authentication, message delivery, and associated business rules. The use of a COTS business rules engine may allow developers to concentrate on the business object logic modules. The business rule engine may also use open source, or proprietary, scripting languages and web service objects, allowing multiple sourcing. New functionality can easily be added later as stand-alone objects with changes to the script. System administrators distribute only the new business objects and scripts, eliminating the expensive re-compile and re-release cycle of an entire application that may be traditionally associated with custom software. In addition, new services may be discovered using a discovery protocol, such as, for example, universal description discovery and integration (UDDI). New service discovery may be performed. automatically and integrated with little or no manual configuration.

The control center service oriented architecture interface software may include a business rules logic module 65, SOA messaging module 66, and may comprise one or more individually network addressable software modules (or objects). The software modules may include a threat management module 70, a remote management module 72, and/or a maintenance server module 74. The threat management module 70 may be configured to provide services associated with the scanning system itself. For example, these services may include: false alarm processing, confirmed weapons processing, machine utilization processing, machine performance processing, collecting information on scanned items, system identified possible threats and skip count, collecting (and/or archiving) images for all scanned items, system identified possible threats and skip count, logging actions taken, connecting to (i.e. sending and receiving data to/from) “parent” and/or “child” control centers. The threat management module 70 may include functions for providing an operator interface (at security device) to perform operator determination of threats such as weapons, explosives, or the like from remote location, set/clear threats, set/clear alarms, log actions taken, and/or the like.

The remote management module 72 may be configured to provide services for remotely managing the hardware platform that a system may be running on. For example, the remote management services may include: system time synchronization; rebooting the security device and/or sensing system; gathering and reporting security device status; supporting and providing backup and/or recovery capabilities at a control center and/or a security device; providing system administration functions (for example, managing system user IDs and passwords); providing ability to schedule tasks; logging actions taken; viewing system log files; connecting to (i.e., sending and/or receiving data to/from) “parent” and/or “child” control centers.

The maintenance server module 74 may be configured to provide services, such as, for example, including: receiving files (e.g., updated signature and/or code files); sending the updated files to the associated security devices for installation/update; providing configuration management (CM) of data deployed or scheduled for deployment; providing ability to schedule distribution; viewing download schedule; viewing versions deployed; viewing configuration management of stored files, or the like.

FIG. 4 provides a block diagram representation of an exemplary service oriented security device management network 100, which may include, for example a hierarchical arrangement of control centers and airport security equipment. In particular, a command and control center 102 may form a top level of a system hierarchy (e.g. a national or international control or command center) and may be interconnected by a network 112 to a next level comprising command and control centers 104 (e.g. a regional control or command center). A command and control center 104 may be interconnected with a threat scanning machine 106 by the network 112. A command and control center 104 may be interconnected to command and control center 108 and to command and control center 110 via the network 112. A command and control center 110 (e.g. an airport, or other facility control or command center) may be interconnected to one or more threat scanning machines 106 via the network 112.

The exemplary service oriented security device management network 100 shown in FIG. 4 may represent, for purposes of illustration, an exemplary configuration of command and control centers connected to each other and to threat scanning machines (security devices). However, it should be appreciated that the network 100 can be configured in order to be adaptable to various contemplated uses of the present invention. The configuration of the network 100 may be static or dynamic depending on contemplated uses of the invention. In an exemplary embodiment, a transportation facility may have an existing network (not shown), and in such a case, the service oriented management network 100 may be adapted to the existing network. Alternatively, in another exemplary embodiment, if an existing network within a transportation facility is insufficient to be able to adapted to meet the communications requirements of the threat service oriented management network 100 for any reason, such as low bandwidth or poor security, for example, then a new network can be installed for the service oriented management network 100 to communicate over. However, it should be appreciated that any communications medium that allows the threat scanning machines and the control centers to communicate may be used with equal success. In an exemplary embodiment of the invention, the command and control centers and the threat scanning machines communicate over the network 112 using standard protocols common in the industry. Examples of standard protocols include, for example, HTTP, IIOP, RMI, SMTP, SSL, SHTTP and the like. Examples of the network 112 include wired or wireless solutions such as Ethernet, fiber optic, or the like. However, it should be appreciated that any present or future developed networks and/or network protocols which perform the tasks required for a command and control center to communicate with a threat scanning machine may be used with the present invention.

In operation, the exemplary command and control center 1 10 communicates with one or more threat scanning machines 106 via the network 112. The command and control center 110 may transmit data to the threat scanning machine, for example, operational software, authorized users and credentials, threat profiles, etc via service oriented messaging. The operational software may comprise any combination of software for the operation of the scanning system and/or software for the operation of the service oriented management network 100. The authorized users and credentials, which may include, for example, a list of user login names and passwords. Threat profiles may include data that the threat scanning machine uses to aid in identification of threats, for example the shape of potential threat items, and/or the physical properties of an item that may indicate a potential threat. However, it should be appreciated that the data transmitted from the command and control center 110 to the threat scanning machine 106 may be any data required for the management and operation of the threat scanning machine and could be used with equal effectiveness according to the present invention.

The exemplary threat scanning machine 106 communicates with the command and control center 110. The threat scanning machine may receive data from the command an control center 110 and/or may transmit data to the command and control center 110. The data that the threat scanning machine may transmit to the command and control center 110 may include, for example, performance data, requests for operator assistance, threat. detection data, and/or the like.

The exemplary command and control center 110 may communicate with one or more command and control centers 104 and/or 102. In the exemplary embodiment shown in FIG. 4, the command and control centers 110 may be interconnected to command and control centers 104. The command and control centers 104 may be interconnected to command and control center 102. In this exemplary embodiment and configuration of the present invention control centers are arranged in a hierarchical manner to provide for the centralized management of many threat scanning machines 106 from a central command and control center 102, thus providing more efficient management of the threat scanning machines 106.

An exemplary. embodiment of the disclosed service oriented security device management network may provide centralized control and management of one or more services from disparate (different devices from different manufacturers) security devices. The services may include remote and system management services. For example, remote and system management services may include access security and auditing; property management and inventory; software inventory, distribution and configuration management; remote hardware/network/software diagnostics; event and status notification, and escalation; data archiving, backup, purging and management; remote access to security devices and command center assets; remote restart monitoring; and/or the like.

The service may also include equipment (security device) specific processing, which may include, for example remote configuration of individual security devices; threat image insertion for security devices; scoring the accuracy of security device operators; staged storage of images and data; interpreting and reporting security device performance data; remote viewing of security device acquired images; searching, displaying, and managing threat data over a distributed network; interfacing to existing security devices; updating of security device software and/or data libraries; screener performance measurement and efficiency reporting; escalation of detected threats; screener/supervisor communication; linking of passenger identification between remote databases; linking other security device scans of a specific article; and/or the like.

As discussed above, the disclosed centralized service oriented management system may use a service oriented architecture. A service oriented architecture may include XML, web services, and Internet transport (other transports such as E-Mail may also applicable). The disclosed service oriented management network may provide a capability for automatic discovery of new security devices and/or new services. The disclosed service oriented management network may provide include HTTPS or WS security to secure message routing and authentication. The disclosed service oriented management network may include “open source” business engines and scripting to implement routing, tracking, authentication, message delivery and associated business logic rules.

The disclosed service oriented management network may provide a capability for new and/or updated capabilities to be added with a change of a script. Further, the disclosed service oriented management network may provide a capability for additional security devices to be added to the system by providing a “plug-in” interface module. This “plug-in” interface module may include a separately programmed application, an agent that resides on the security device itself, or a plug in dynamically linked library (DLL) module that plugs into a generic interface module.

The disclosed service oriented management network may provide a capability for additional capabilities to be added to the server by adding base functionality as generic modules and changing the business engine script, which may be an “open source” script. In other words, the script may be accessible by a variety of appropriate developers for adding and/or updating functionality. The service oriented architecture of the disclosed system may also provide for the partitioning of a system into tiers. For example, the management system may be partitioned to include a presentation tier including graphical user interfaces, a business tier including business rules, a database tier including the data layer, and or the like. The partitioning may prevent software coupling, and may therefore increasing reuse and may decrease costs of software upgrades and modifications. Also, XML tags of a service oriented architecture services may be included to facilitate easy grouping, searching, and aggregiation of data of the raw data stream (permitting easy aggregation, filtering, and forwarding of data for a hierarchical management structure) and easy storage to databases.

An exemplary central management network structure for security devices may be implemented in a hierarchical structure as shown in FIG. 4. In operation, multiple airport security devices may be monitored and controlled in multiple airports at an airport command center. The status of each airport command center and aggregated status of all security devices within each airport may be monitored at one ore more regional command centers. Regional command centers may also be allowed to provide all functionality of an airport command center. Likewise, the status of any regional command center and aggregated status of all security devices and airport command center status may be monitored at one or more national command centers. A national command center may also provide any functionality of an airport command center or a regional command center.

Each security device may have a security device interface assigned to it, or alternatively, multiple security devices may be serviced by one interface module. The security device interface may be configured to provide communications, security, connectivity, and control of the messages. The actual implementation of the interface may be a business rule engine that controls the routing of messages to internal plug in modules. In this implementation requests may be received from a control center and routed to the business engine. The business engine may be implemented in custom software or it may be implemented with a COTS Business Rule Engine with scripting to control individual message routing. COTS Business Rule Engines typically also include the communication and security functions to communicate over a web service interface (shown in the SOA Communication Module in the diagram). The business engine routes the message to the appropriate internal software module as shown in the following diagram.

These software modules may be implemented in service oriented architecture themselves and be based on web services, or may be software modules including agents, plug in dynamic link libraries (DLLs), applications, services, daemons, routines, and/or the like, that run on the security devices, or on other computers for the purpose of providing an interface between disparate security devices and centralized command and control centers. The interface module services may also be implemented as hard-coded modules within the interface itself.

The disclosed service oriented management network may be configured to provide one or more centralized management functions. A centralized management function may include, for example, property management; hardware inventory; software inventory; software distribution; configuration management; remote hardware/network/software diagnostics; alarm, error, and warning event status notification, and escalation; data archiving, backup, purging and management; remote access to security device and command center assets; user and system authentication and authentication setup; auditing of some or all actions taken; auditing of some or all messages received; routing of command signals; remote configuration of individual security devices; threat image insertion management; scoring the accuracy of security device screeners; staged storage of images and data; interpreting and reporting security device performance data; remote viewing of images acquired by a security device; searching, displaying, and managing threat data over a distributed network; update of security device threat libraries; screener performance measurement and efficiency reporting; escalation and management of detected threats, and alarms; screener/supervisor communication; linking of passenger identification between remote databases; linking other security device scans of a specific article; scheduling update or software/download of files; remote control of screener/user functions; command and control of security device; gathering of computer/system/user diagnostic data; remote training of users; storing and queuing of information; configuration of the security device; report generation; remote desktop sharing; reporting security device utilization; reporting security device performance; communication of data, image, training, configuration, audit, database, and/or registry data to a central command center for centralized management, archiving, or temporary storage; capturing and reporting of security device operator keystroke information; remote restart monitoring; screener user tracking and time keeping; traveler identification information gathering, comparison to existing databases, and correlating to baggage; security encryption of data stream.

FIG. 5 is a flowchart 200 representing an exemplary disclosed method for managing a network of security devices. In particular, after start (step 202) the method continues with automatically or manually identifying a security device to add to the service oriented security device management network (step 204). For example, when a new device is to be added to the management network it may be identified manually by an operator, or automatically via service oriented communication between the new device and a control center.

Once the security device has been added to the network, an individually network addressable object is associated with the security device (step 206). This may be an object that resides in a control center or in a service security device network interface module. A business rule engine may provide a service by accessing the individually network addressable object based on a script (step 208). The security device may be monitored from a control center via the service provided by the business rule engine (step 210). Monitoring may include aspects such as, for example, communicating, managing, observing, updating, or the like between the control center and the security device.

An optional service discovery mechanism may be provided to allow a control center and/or a security device to obtain a listing of available services (step 212). Also, a compromised or defective security device and/or service may be detected and removed from the management network if appropriate (step 214). The removal may be accomplished automatically, manually, or through a combination of the above. Automatic removal may be performed when an object manager or rule engine detects a problem with a service and removes the service from a list of available services. Alternatively, the management system could propagate a message throughout the network indicating that a service has been removed. The method ends at step 216. All or a portion of the method may be repeated to provide management of a service oriented security device network. It should be appreciated that the disclosed systems and methods may be implemented in one or more modules comprising hardware, software, or a combination of the above. Further, the disclosed systems and methods may be contained in one module or processor, or may be distributed across more than one module and/or processor.

FIG. 6 provides a flowchart 300 representing an exemplary disclosed method for upgrading a security device. In particular, after start (step 302) the method may include automatically or manually identifying a security device to upgrade (step 304). After a security device has been identified for upgrading, a service oriented security device network interface may be provided (step 306). The service oriented security device network interface may be coupled to the security device (step 308) and the network (step 310). Once the security device is coupled to the network via the service oriented security device network interface, a service oriented message may be transferred from the security device via the service oriented architecture security device interface to a control center coupled to the network. The method ends at step 312. The method may be repeated in whole or in part as may be desired to upgrade security devices.

As shown in the above figures, the security device network management system and methods can be implemented on one or more of a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, a router or switch, or the like. In general, any component capable of implementing the functions described herein can be used to implement the system and methodology according to this invention.

Furthermore, the disclosed service oriented security device management network may be readily implemented in software using object or object-oriented software development environments that provide portable source code that can be used on a variety of computing platforms. Alternatively, the disclosed service oriented security device management network may be implemented partially or fully in hardware using standard logic circuits or a very large-scale integration (VLSI) design. Other hardware or software can be used to implement and supplement the systems in accordance with this invention depending on the speed and/or efficiency requirements of the system, the particular function, and/or a particular software or hardware system, microprocessor, networking, or microcomputer system being utilized. The system illustrated herein can readily be implemented in hardware and/or software using any known or later developed systems or structures, devices and/or software by those of ordinary skill in the applicable art from the functional description provided herein and with a general basic knowledge of the computer and network communication arts.

Moreover, the disclosed methods may be readily implemented in software executed on programmed general-purpose computer(s), a special purpose computer, a microprocessor, or the like. In these instances, the systems and methods of this invention can be implemented as a program such as JAVA® or a script embedded on a personal computer, as a resource residing on a server or graphics workstation, as a routine embedded in a dedicated network system, or the like. The system can also be implemented by physically incorporating the system and method into a software and/or hardware system, such as the hardware and software systems of a network.

It is, therefore, apparent that there is provided in accordance with the present disclosure, a service oriented security device management network. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. An interface for coupling a security device to a service oriented management network, the interface comprising:
a service oriented security device network interface module configured to provide system access protection for the security device and message routing for each security device coupled to the interface; and
a security device interface module coupled to the service oriented security device network interface module, the security device interface module including:
a service oriented architecture communications module coupled to the service oriented security device network interface module;
a rule engine coupled to a database and the service oriented architecture communications module;
at least one functional software module couple to the rule engine and configured to provide a security device service; and
at least one translator software module coupled to the rule engine and to the security device and configured to translate data or commands in a control center format into a format suitable for use in the security device, wherein the rule engine is configured to control the routing of an internal message to the at least one functional software module or the at least one translator software module based on a script, and
wherein the interface is configured to automatically couple additional security devices to the service oriented management network and automatically remove a security device from the service oriented management network.

2. The interface of claim 1, wherein the security device is disposed in an airport.

3. The interface of claim 1, wherein the interface is disposed within the security device.

4. The interface of claim 1, wherein the interface is disposed in an external device capable of network communications with the security device.

5. The interface of claim 1, wherein the security device service is selected from one of a property management service, a hardware inventory service, a software inventory service, a software distribution service, a configuration management service, a remote diagnostic service, an alarm notification service, an alarm escalation service, a data archiving service, a remote access service, a user authentication service, an auditing service, a command signal routing service, a remote configuration service, a threat image insertion management service, a security device screener accuracy scoring service, a staged storage service, security device performance interpretation and reporting service, a remote viewing service, a threat data management service, a security device threat library update service, a screener performance measurement and efficiency reporting service, a communication service, a remote passenger information database linking service, an image linking service, a software update service, a remote control service, a security device command and control service, a diagnostic gathering service, a remote training service, an information storing and queuing service, a security device configuration service, a report generation service, a remote desktop sharing service, a security device utilization reporting service, a security device performance reporting service, a central command center data communication service, an operator keystroke capturing and reporting service, a remote restart service, a screener tracking and time keeping service, a traveler identification information gathering and comparison service, and a data encryption service.

6. A security device management system comprising:
at least one control center coupled to a network, the control center including:
a business logic rules module configured to determine a need to provide or consume a service; and
a service oriented architecture messaging module configured to send a message requesting a service and to send a message responding to a request for service;
at least one service oriented security device network interface coupled to the network; and
at least one security device interface module coupled to the at least one service oriented security device network interface, the at least one security device interface module including:
a service oriented architecture communications module configured to communicate with the service oriented architecture messaging module of the at least one control center via the network;
a business rules engine coupled to the service oriented architecture communications module;
at least one functional software module coupled to the business rules engine; and
at least one translator software module coupled to the business rules engine.

7. The security device management system of claim 6, wherein the at least one service oriented security device network interface and the at least one security device interface module are each configured to automatically couple one or more security devices to the network.

8. The security device management system of claim 6, wherein the at least one security device interface module further includes a module for adding a newly connected security device to the security device management system.

9. The security device management system of claim 6, wherein additional capabilities may be added to the at least one control center by adding a service oriented object to the at least one control center and modifying a script in the business logic rules module.

10. The security device management system of claim 6, wherein additional capabilities may be added to the at least one security device interface module by adding a service oriented object to the at least one security device interface module and modifying a script in the business rules engine.

11. The security device management system of claim 6, wherein the system is configured to monitor the status of at least one security device and collect information associated with the at least one security device using a service oriented architecture to establish communications between the control center and the at least one security device.

12. The security device management system of claim 6, wherein the system is configured to automatically remove a security device from the network.

13. A method of managing a network of security devices using a service oriented architecture, the method comprising:
identifying at least one security device and associating at least one individually addressable network object with the at least one security device;
providing a service including the at least one individually addressable network object and a business rule engine having at least one script; and
monitoring the at least one security device from at least one control center by using the service provided by the at least one individually addressable network object and the at least one script.

14. The method of claim 13, further comprising a service discovery mechanism such that the at least one control center and the at least one security device may obtain a listing of services available.

15. The method of claim 13, further comprising providing an automatic introduction mechanism such that when a new security device is added to the network of security devices, its location and identity may be automatically retrieved by the at least one control center using a service oriented messaging system.

16. The method of claim 13, further comprising removing a compromised or defective service or security device from the network.

17. A security device monitoring node for use in a service oriented architecture, the security device monitoring node adapted to associate at least one individually addressable network object with at least one security device, to provide a service including the at least one individually addressable network object and a business rule engine having at least one script, and to permit the at least one security device to be monitored from a control center by using the service provided by the at least one individually addressable network object and the at least one script.

18. The security device monitoring node of claim 17, wherein the service is selected from one of a property management service, a hardware inventory service, a software inventory service, a software distribution service, a configuration management service, a remote diagnostic service, an alarm notification service, an alarm escalation service, a data archiving service, a remote access service, a user authentication service, an auditing service, a command signal routing service, a remote configuration service, a threat image insertion management service, a security device screener accuracy scoring service, a staged storage service, security device performance interpretation and reporting service, a remote viewing service, a threat data management service, a security device threat library update service, a screener performance measurement and efficiency reporting service, a communication service, a remote passenger information database linking service, an image linking service, a software update service, a remote control service, a security device command and control service, a diagnostic gathering service, a remote training service, an information storing and queuing service, a security device configuration service, a report generation service, a remote desktop sharing service, a security device utilization reporting service, a security device performance reporting service, a central command center data communication service, an operator keystroke capturing and reporting service, a remote restart service, a screener tracking and time keeping service, a traveler identification information gathering and comparison service, and a data encryption service.
